(19) United States
(12) Patent Application Publication
(10) Pub. No.: US 2026/0147821 A1
(43) Pub. Date: May 28, 2026

(54) ADAPTIVE CONTENT GENERATION SYSTEM

(71) Applicant: Channel 1, Inc., West Hollywood, CA (US)

(72) Inventors: Adam Mosam, Mississauga (CA); Christopher Scott McKinley, La Canada Flintridge, CA (US); Jerry JinJia Qu, Scarborough (CA); Justin Tsutomu Fujita, San Marino, CA (US); Scott Younce Zabielski, Burbank, CA (US)

(21) Appl. No.: 19/402,379

(22) Filed: Nov. 26, 2025

Related U.S. Application Data
(60) Provisional application No. 63/725,589, filed on Nov. 27, 2024.

(51) Int. Cl. G06F 16/432; G06F 16/487; G11B 27/031

(52) U.S. Cl. CPC G06F 16/432; G06F 16/487; G11B 27/031

(57) ABSTRACT

An example operation may include at least one of ingesting video files sourced from a plurality of communication devices, generating metadata of the video files which identifies attributes included in playable content of the video files and pairing the metadata with the video files in a database, receiving, by a software application, an input request comprising an identifier of a topic, retrieving a subset of video files among the video files stored in the database which contain metadata that matches the topic, generating a script for a story about the topic based on execution of an artificial intelligence (AI) model on the subset of video files, and generating a video file with footage that follows the script and playing the video file through a user interface of the software application.

### BACKGROUND

Video content and other media are more available today than ever before, largely because consumers can obtain the content through many different channels using a smartphone. Omnichannel distribution enables consumers to obtain content through multiple channels in a way that best suits their needs. Furthermore, the amount of content that is available and the number of sites and other sources that provide the content is vast. A content consumer can spend significant time sifting through content that is not of interest, just to find and consume content that is of interest.

### BRIEF DESCRIPTION OF THE DRAWINGS

FIG. 1A is a diagram illustrating a system for generating and playing content using existing content according to an embodiment of the instant solution.

FIG. 1B is a diagram illustrating a process for generating a news story according to an embodiment of the instant solution.

FIG. 1C is a diagram illustrating a process of using artificial intelligence to extract context and metadata from ingested content according to an embodiment of the instant solution.

FIG. 1D is a diagram illustrating a process of prompting a computer model to generate a news story according to an embodiment of the instant solution.

FIG. 2A is a diagram illustrating a process of playing content with a first level of detail according to an embodiment of the instant solution.

FIG. 2B is a diagram illustrating a process of modifying the content being played to have a second level of detail according to an embodiment of the instant solution.

FIG. 3 is a diagram illustrating a computing system for use in any of the example embodiments according to an embodiment of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

FIG. 6 is a diagram illustrating a method of dynamically generating video content according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a complete toolset for the modern newsroom which leverages artificial intelligence (AI) to create news stories, dynamically generate the news stories in different languages, formats, etc., and provide a viewer with the ability to dynamically adjust the level of detail in the content within the news story. Create stories in multiple formats, design virtual presenters and fully customize your brand voice. Publish and syndicate stories to social media, FAST/VOD feeds, your apps and custom destinations. Contextual search for your entire library. Update stories, create new versions and distribute to more endpoints. Interpret performance data and discover new insights into your content. Extend existing campaigns and plug into new monetization opportunities for your content.

The system can receive delivery of a completed video or export the video into popular video editing file/timeline formats. The system can generate imagery, B-roll or music for use in the story to ensure a complete video package, and the like. The system can select from a range of templates suitable for different types of stories or enable users to dynamically create their own. The system can translate the story into multiple languages and serve a global audience.

The system may include various components, for example, a script Editor that may lead with a hook, clearly introduce subjects, clear beginning/middle/end, edit down for time while keeping key points intact. The system may also include a fact checker that is programmed to use only facts from the original reporting and displaying those to human editors. The system may also include an anchor selector which suggests an appropriate anchor from a library of anchors and tone based on a type of story.

The system also includes a sound bite editor that may edit down interviews from raw footage to provide most relevant bites and place them at appropriate parts of the package, and a sound bite translation that identifies foreign language sound on tape (SOT), translates, generates translator voice, dips original voice volume and overlays translator audio. The system may also include a module that can analyze, edit and place b-roll. For example, the module may analyze, select and cut down b-roll and match it to relevant parts of the story while following custom rules. The system may include an automated graphics module which identifies where graphics are necessary for chyron, story location, interviewee name then generates and places them. The system may also include a music scoring module which determines whether music is necessary for story format, selects music based on story tone, edits down and places music.

Furthermore, according to various embodiments, the system may include a machine learning (ML) service which includes one or more ML models with generative capabilities that can create/generate content. For example, the ML service may receive an identifier of a topic of interest and generate a video with news content. The video may include an anchor (e.g., synthetically generated or based off of known/real anchors), and content that is discussed, shown, or otherwise output during the video. The system also includes a storage with a library of existing news stories (e.g., videos, descriptions, audio, etc.) which may be indexed based on attributes of the news stories such as location, time of occurrence, topic, and the like. Existing video and created clips can be indexed and searchable for future use. Voice can be removed from B-roll where necessary. Materials can be used to create new versions of the story to be re-published to more platforms.

The ML Service can infuse a broadcaster's brand into the writing, editing and graphics. Many different aspects are taken into account such as target demographics, proven audience interests, core brand elements, supporting graphics, tone and speed of delivery, visual pacing of stories, style of music, and the like. The system can automatically detect brand elements from provided video samples. Analysis can reveal tone, speed, pacing, musical style, and more.

The system provides consistency across platforms and can customize content for various platforms while preserving underlying facts. The system can create concise versions, add music and compelling intros aimed towards a particular audience (e.g., young, old, specific demographics, etc.), and the like. The system is designed for consuming news directly on platform instead of re-directing elsewhere.

The system can create playlists and feeds for both FAST and VOD output. The system can seamlessly export the created content into existing systems. Create custom output specifications for download, API access, webhooks, or cloud storage.

The example embodiments also provide a dynamically modifiable user experience for users while they are viewing the news stories. In today's world, there is a constant bombardment of information which often causes users to spend too much time searching for content they want to see. Users may navigate a mix of websites, digital subscriptions, news aggregators, social media sites, cable news, and other content sources to try and make sense of the current news stories.

The example embodiments provide a system that can dynamically select a news story of interest to a user from among many possible news stories based on historical preferences of the user, and dynamically display the selected news story in a prominent way on the user's device. The system intuitively knows which news is more interesting to the user, and which news is not, thereby managing the news stories that are seen by the user without requiring the user to sift through the different news stories and select their story of interest.

The system learns a user's preferences by tracking watching activity including how the user interacts with videos and how long the user watches the videos. The system may build a knowledge graph for the user as the user consumes news stories and other information. Thus, the system creates a personalized data set for the user which can be used to select the news story (video content, etc.) that is of interest.

The system relies on artificial intelligence/machine learning algorithms to select videos and other content of interest. The system can also customize the content being shown to the user including how much detail is being provided by the news story. For example, the system can output the content such that it has few enough details and is easy to understand content such that it is understandable to a child. As another example, the system can generate the news story with significant details that are of interest to an adult that views the news every day.

The system may select the most appropriate version of the news story for each user when there are multiple available. The current playing version may be shown by an indicator on the screen. The indicator may include a grid with a plurality of boxes or cells. The location of the indicator within the grid represents the level of detail of the content that is currently being played. A user may click on the grid with their finger and select a different cell from the grid which triggers the software to stop the content with the current level of detail from being played, and replace it with the content at a different level of detail corresponding to the different cell. Thus, a user can change how much data they are being provided with their news story by simply clicking on the grid on the screen.

The system also enables the user to converse with the software using audible commands and speech. For example, a user can ask for a video they are watching to be sent to another user or group of users (e.g., friends, etc.)

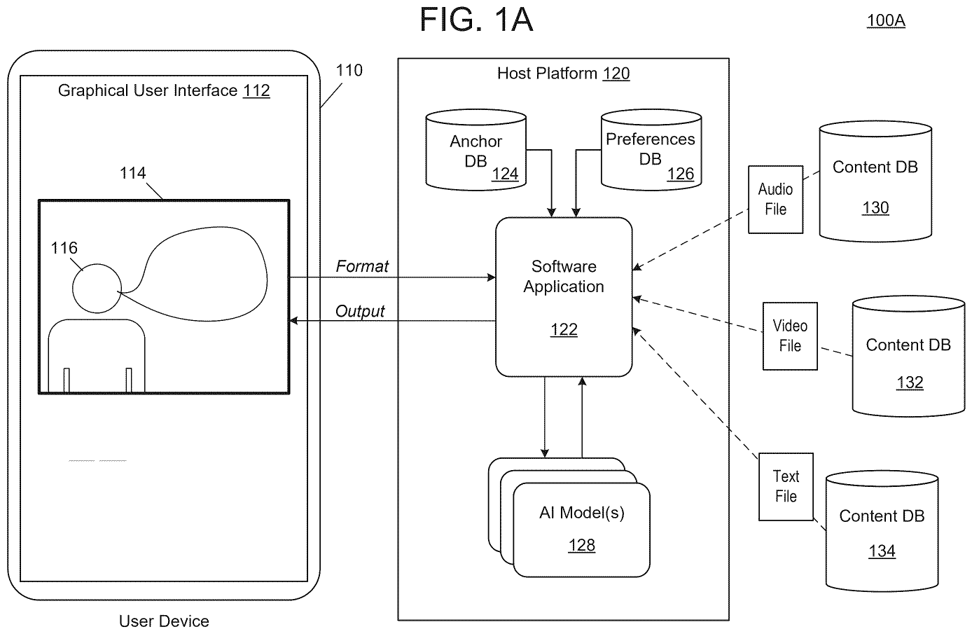

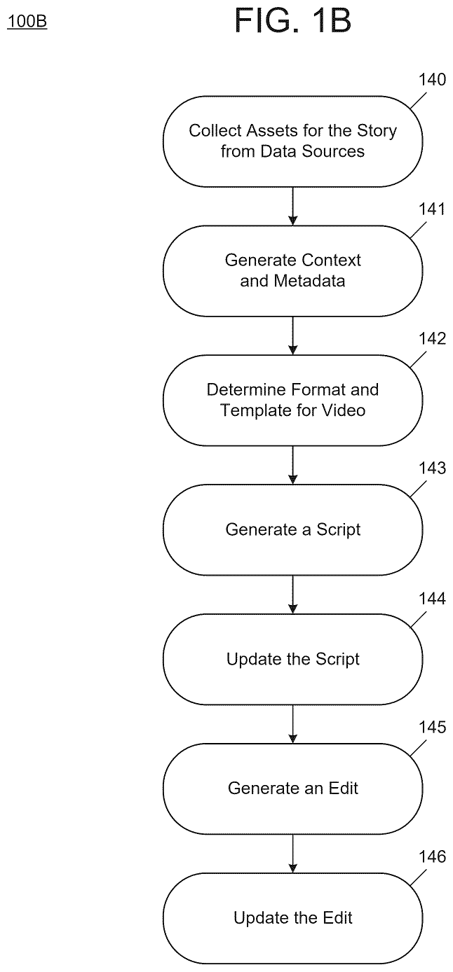

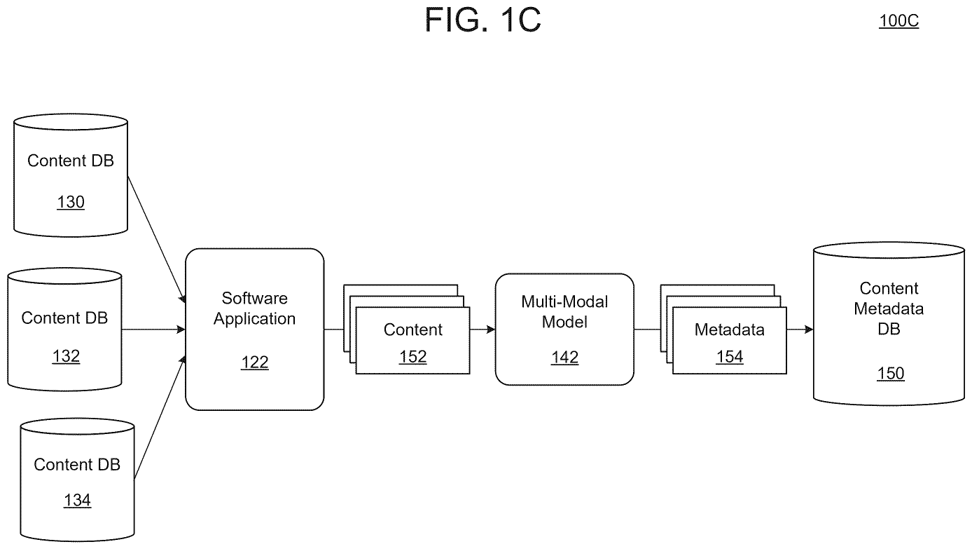

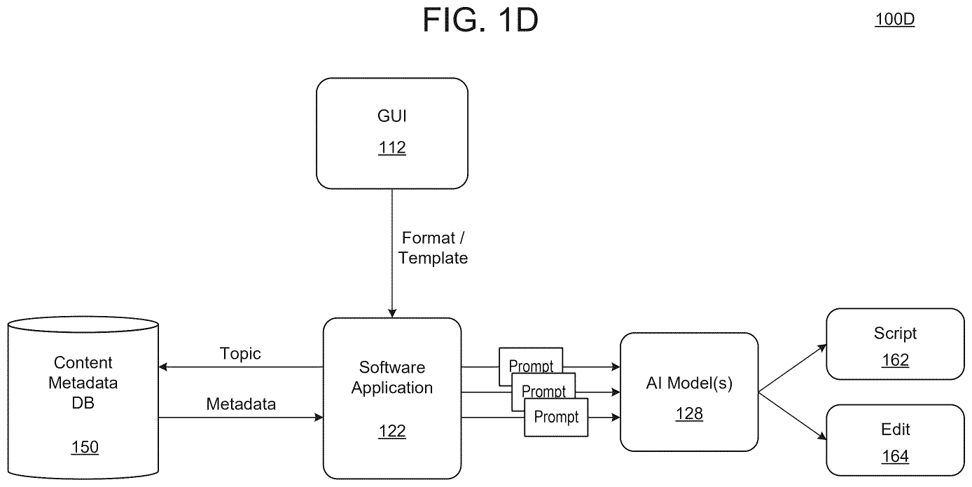

FIG. 1A illustrates a system 100 for generating and playing content using existing content according to an embodiment of the instant solution. Referring to FIG. 1A, a host platform 120 hosts a software application 122 that is capable of generating and playing content including audio, video, text, people (e.g., news anchors), and the like. The host platform 120 may be a cloud platform, a web server, a database, and the like. A user may connect to the software application 122 with a user device 110. For example, the user may install a front-end of the software application 122 locally on the user device 110. As another example, the software application 122 may be a web application that can be accessed over the Internet. In this example, the user may enter an IP address of the software application 122 into a browser installed on the user device 110 and navigate to the software application 122.

In the example of FIG. 1A, the software application 122 outputs a graphical user interface (GUI) 112 which can be viewed on a display screen of the user device 110. For example, the software application 122 may select a news story that is of interest to the user of the user device 110 and output content 114 from the news story into the GUI 112. In this example, the content 114 includes an anchor 116 describing a news story. The decision on which news story to show the user may be dynamically performed by the software application 122. For example, the software application 122 may select the news story from among multiple possible news stories based on preferences of the user which are stored in a preferences database 126. In this way, the software application 122 can decide which news story will be of most interest to the user based on the user preferences, and automatically output the news story such that the user does not need to sift through the multiple possible news stories to find the news story of interest.

As another example, the software application 122 may generate content for the news story. For example, the software application 122 may query one or more AI models 128 with a topic of interest. In response, the one or more AI models 128 may receive metadata from different pieces of content corresponding to the topic of interest from one or more content data sources, such as content database 130, content database 132, and content database 134. The content may include video, audio, text, images, and the like. The metadata may include attributes of the content generated by the software application 122 (e.g., using an LLM, etc.) such as speech transcribed from the content, words on the screen, words within signage, shot time, time of day, location data (e.g., surroundings, environment, etc.), what actions are occurring in the footage, identification of people (e.g., names, etc.), user reviews/rankings of the content, minimum on-screen recommend time, and the like.

The one or more AI models 128 may generate a news story, including an anchor, which includes content that can be consumed by the user. The decision on which anchor to use can be based on predefined anchors stored within an anchor database 124. Here, the anchors may be real-life anchors that are included within the generated content. As another example, the anchors may be synthetic anchors that are generated by the one or more AI models 128. In some examples, the one or more AI models 140 may include one or more LLMs, but embodiments are not limited thereto.

FIG. 1B illustrates a process 100B for generating a news story according to an embodiment of the instant solution. For example, the process 100B shown in FIG. 1B may be performed by the software application 122 shown in the example of FIG. 1A, however, embodiments are not limited thereto. Referring to FIG. 1B, in 140, the software application may collect content (e.g., source material, etc.) for generating a news story. For example, the content may include text, video, audio, images, and the like, which a user can select from sources from a newswire (e.g., the Associated Press, Reuters, etc.), from a website, from a document, upload a video, and the like. In some embodiments, the user may designate each piece of content as primary or secondary. If designated as primary, it contains some elements that would influence the story. If secondary, it may only be used as footage.

In 141, the software application may ingest the incoming source material and index it by running it through a multi-modal computer model to generate context and metadata. As an example, the multi-modal computer model may be a large language model (LLM) that can process and understand multiple types of data simultaneously including text, images, audio, video, and the like, and generate outputs based on the combined information from these different modalities. The computer model may generate a significant amount of metadata for each piece of content including transcribing and translating any speech, reading any words or on-screen signage, understanding shot time, time of day, surroundings/environment, what's happening in the footage, identify people, ranking (e.g., between 1 and 10, etc.), minimum on-screen recommended time, and the like. Metadata artifacts may be vectorized into standardized and proprietary encoding formats and ingested into database systems that enable large-scale semantic-search recall across all cumulatively indexed multi-modal materials enabling relevant recall in subsequent RAG (retrieval augmented generation) in content generation.

In 142, the software application may receive a requested output format (e.g., YouTube, Tik Tok, Twitter/X, TV, etc.) and a requested output template (e.g., social media, business report, entertainment news, etc.) for the news story (e.g., video, etc.) that is being requested. Here, a user may input the output format and the output template via a user interface of the software application 122. Some brands have strictly-typed templates and some are more open. Template determines the formation of the script and the style of editing/graphics/etc.

In 143, the system may generate/write a script for the new story using a series of prompts that are input to an artificial intelligence model such as a LLM. For example, the system may use a chain of thought prompt style which can trigger the LLM to write the story in a particular output template and format. It's a different prompt chain for each template. In 144, the user can optionally make modifications to the automatically generated script. The user can use the GUI 112 of the software application 122 to make the modifications by inputting commands into the GUI using input mechanisms displayed on the GUI 112.

In 145, the system may generate an edit of the script (e.g., revise the script for accuracy, clarity, conciseness, adherence to style guidelines, fact-checking, grammar checking, spelling checking, punctuation checking, etc.) In this example, the software application may input a series of prompts chained together to an artificial intelligence model such as an LLM. In 146, the user can optionally make manual adjustments to edit the script via the GUI 112 of the software application 122.

The resulting news story may include a video with spoken content by an anchor. The spoken content may be based on the script that is generated and edited by the artificial intelligence system described herein. The news story may be stored in a storage device such as a repository. As another example, the news story may be output to a video player which may be embedded in the GUI 112 of the software application. The video player may play the news story enabling a viewer to watch the news story.

In some embodiments, the LLM or group of LLMs used by the example embodiments can ingest content that is specific to a particular brand. For example, a broadcaster such as a news agency, website, or the like, may have specific brand attributes such as graphics, anchors, styling, pacing, tone, etc., that are specific to their brand. The software application may input finished content from the specific broadcaster into the LLM(s) when generating the script and the edit causing the model to learn the brand-specific attributes and incorporate them into the content that is generated.

Furthermore, the LLMs that are part of the AI service may be trained to understand the difference between scripts or edits generated by the AI service and corrections that are made by the user(s). For example, a news story may be run through the AI service first, then corrected by a human and fed back into the AI service. That helps teach the model(s) how to do its job better.

Additional LLMs, models, and customized internal agents can operate platform tooling and services independently and collaboratively with traditional human system users in further automating the functions of content authoring, production, and editing. Internal platform AI agents may serve as editorial assistants, or copywriters, or fact-checkers in shepherding deliverables through the generative process.

In some embodiments, an agentic asset collection module of the software application initiates the video generation workflow by autonomously interfacing with a plurality of heterogeneous data sources to retrieve media assets relevant to a designated story or narrative. The AI agent orchestrates simultaneous queries across licensed content providers including, but not limited to, newswire services (e.g., REUTERS®, AP®, AFP®, etc.), stock media repositories (GETTY®), and enterprise digital asset management (DAM) systems. The collection process employs intelligent prioritization algorithms that evaluate source licensing parameters, content freshness, and client-defined preferences to curate an optimal asset pool. This automated, AI-driven ingestion eliminates manual asset hunting and ensures comprehensive coverage of available source material before downstream processing commences.

Additionally, the asset collection module transforms the client's entire enterprise video archive into an active, searchable resource by indexing historical content alongside newly ingested material. This unified approach enables the AI agent to retrieve the optimal clip from both legacy assets and real-time licensed feeds within seconds, maximizing content reuse and reducing redundant acquisition costs. The system maintains persistent connections to the organization's existing content management systems (CMS) and digital asset management (DAM) platforms, ensuring seamless integration with established enterprise workflows.

In some embodiments, an AI-powered contextual analysis engine of the software application processes the collected assets to generate multi-dimensional metadata organized across temporal layers. The system performs deep footage analysis utilizing computer vision models to identify objects, actions, persons, sentiment, and semantic content within each asset. Critically, the metadata generation encompasses multiple layers of time including: capture timestamp, event chronology, narrative sequence position, and publication timing constraints. The AI agent assigns structured metadata tags through a hybrid verification process comprising both technical validation (e.g., format verification, resolution analysis, codec compatibility etc.) and AI-driven semantic verification (e.g., content accuracy assessment, contextual relevance scoring, and cross-reference validation against source material, etc.).

This richly annotated metadata layer serves as a foundational index that enables intelligent retrieval and automated editorial decision-making in subsequent processing stages. The deep footage analysis capabilities extend to identifying specific high-value moments within each asset, such as a winning goal in a sports match or a key quote in an interview, ensuring that the most compelling and impactful content is surfaced for editorial consideration. This automated moment detection eliminates hours of manual logging traditionally required in video production workflows. The resulting metadata index renders the entire content library instantly searchable by semantic concept, enabling downstream AI agents to locate precisely relevant footage based on narrative requirements rather than relying solely on filename or manual tagging conventions.

In some embodiments, a template determination module of the software application analyzes the target output requirements and selects an appropriate format and template configuration from a client-specific template repository. The AI agent evaluates multiple parameters including target distribution platform specifications (linear broadcast, VOD, FAST channels, social media formats such as TIKTOK®, INSTAGRAM®, and YOUTUBE®), duration constraints, aspect ratio requirements, and brand governance rules. The system retrieves client-specific templates comprising style parameters that encode the organization's visual identity including graphics packages, transition preferences, pacing guidelines, and tonal characteristics. This automated template matching ensures that all generated video outputs conform to enterprise brand standards while optimizing for the designated distribution channel.

The template determination module further supports multi-language output transformation, enabling video adaptation and distribution in more than thirty languages from a single source production. The system accounts for language-specific duration differentials and cultural presentation norms when selecting template configurations, ensuring that localized outputs maintain visual-audio synchronization and brand consistency across all target markets.

In some embodiments, an agentic scriptwriting module of the software application transforms the contextual metadata and source material into a broadcast-ready video script. The AI agent employs natural language processing to parse narrative units from the collected assets and synthesizes these elements into a coherent script comprising dialogue cues, visual descriptors, temporal markers, and presenter instructions. The script generation process leverages machine learning models trained on the client's historical content to capture linguistic patterns, editorial voice, and presentation style. The resulting video-specific script serves as the authoritative blueprint governing subsequent footage selection, audio synthesis, and visual assembly operations. The script generation module further supports the creation of AI presenter directives, enabling the synthesis of on-screen, voice-led, and personality-driven virtual anchors to deliver the narrative content. These AI presenter specifications are encoded within the script structure, defining visual appearance parameters, vocal characteristics, and performance style attributes that guide downstream avatar rendering and speech synthesis processes.

FIG. 1C illustrates a process 100C of using artificial intelligence to extract context and metadata from ingested content according to an embodiment of the instant solution. Referring to FIG. 1C, the software application 122 may ingest content 152 (e.g., text, images, video, audio, web pages, etc.) from various content sources 130, 132, and 134, and pass the content 152 to a multi-modal model 142, such as a LLM. Here, the content 152 may also be referred to as source material for generating a news story (e.g., a video, audio, text, etc.).

According to various embodiments, the multi-modal model 142 may analyze the content 152 and extract metadata 154 from each piece of content and store the metadata 154 in a content metadata database 150. The metadata 154 may include attributes of the content such as speech transcribed from the content, words on the screen, words within signage, shot time, time of day, location data (e.g., surroundings, environment, etc.), what actions are occurring in the footage, identification of people (e.g., names, etc.), user reviews/rankings of the content, minimum on-screen recommend time, and the like.

Once the user has been shown an initial edit of the script, they are given specialized tools and UI components to complete the edit. These include a Chat function (script-chat-inteface.png, script-chat-interface-2.png). Here, a user can chat with AI ‘Prism’ and request changes to script. This includes looking for new research, finding soundbites (SOTs) that may be appropriate for the story, generating new presenter language and ideas. Another function is Inline AI (script-inline-ai.png, script-inline-ai-2.png). Through this, a user can select a single script block and select ‘Ask AI’. This provides a localized context in which to ask AI questions or make requests concerning the highlighted block. If the AI makes changes to that script block, the user is given a choice to either accept or reject those changes.

Another function is Remix (script-remix.png, script-remix-2.png) which provides specialized tools to change the presenter, duration, tone, or level of expertise in the script. This will result in the AI re-writing the entire script and showing the user both versions side by side. If the Presenter is changed, the user has the option to include leveraging the Presenter's personality or having it written without it. Another function is soundbite insertion (script-SOT.png, script-SOT-2.png). With this function, a user can search through all soundbites in a project library and see details of each show including transcription, description and license terms. User can then decide to add with a button or drag in the soundbite onto the script.

Another function is block addition (script-add-block.png, script-add-block-2.png). In this case, if a user would like to add a block to the script, they are given a choice between Presenter, Soundbite, Footage or Element. If a presenter is chosen, they can either start typing, or just type ‘space’ and tell the AI what they want in the script by describing the block and the AI will write it for them. Another function is soundbite editing (SOT-control.png). Here, if a user would like to adjust which part of the soundbite is inserted into the script, they can easily see in a single component the entire transcript of a soundbite and easily control which part is used inside the script using simple sliders on each end for the start and finish position.

In a further unique aspect, an automated editorial assembly engine generates a first-cut video edit by orchestrating the synthesis of visual, audio, and graphical elements according to the verified script. The AI agent leverages the comprehensive metadata layer from step 141 to intelligently select and sequence video footage segments that optimally match the visual descriptors specified in the script. The system performs temporal alignment to synchronize each footage segment with its corresponding narrative unit, synthesizes audio content including AI-generated presenter narration, and applies the template-defined graphics and transitions from step 142. This agentic assembly process produces a complete draft edit that complies with all user requirements, brand specifications, and format constraints without requiring manual intervention.

In some embodiments, the automated editorial assembly is designed to maintain human editorial control by producing a transparent first-cut output that clearly delineates AI-driven decisions for subsequent human review. The system adheres to enterprise-grade quality standards throughout the assembly process, applying consistent brand governance rules and compliance checks that satisfy organizational requirements for professional broadcast and distribution.

The system also provides functions that can be used to update an edit. For example, Chat (video-chat-inteface.png, video-chat-interface-2.png) is a function that enables a user to chat with AI ‘Prism’ and request changes to the video edit. This includes looking for new footage, finding soundbites (SOTs) that may be appropriate for the story, changing pace, adding music, adding captions, swapping footage and much more. A remix function (video-remix.png) allows a user to use specialized tools to change the presenter, duration, format and shot style in the video edit. The footage selection function (video-footage-selection.png, video-footage-selection-2.png) allows a user to search through several types of footage: Library, Archive, External. Details including footage metadata, ownership and licensing terms can be found in an expanded detail view. User can opt to drag footage into the timeline manually or have the AI take care of placing footage for them. If footage comes from an external library, all licensing and entitlements are automatically taken care of by the system. If the user wishes, they can also choose to generate footage to be used in their project.

An element selection function (video-element-selection.png) allows a user to choose from uploaded brand kit elements, graphical elements, video transitions, audio elements and browse each category. Elements can be added into the timeline manually or placed by the AI. A captions addition (video-captions-addition.png) function allows a user to ask the system to add captions to their video project. They can choose from a predefined list of saved styles or create new styles to add.

In some embodiments, an AI-assisted editorial refinement interface enables human-AI collaboration through an interactive user interface that allows the user to conversationally interact with the editorial timeline. The system presents a graphical interface wherein users may select portions of the timeline using a lasso selection tool to isolate specific segments for modification. Users provide editorial direction through what the system terms “executive notes”—high-level feedback instructions delivered via text input or voice commands that the AI agent interprets and executes as timeline modifications. The AI-powered editing process continuously references the metadata layer established in step 141, the template parameters from step 142, the verified script from step 144, and the initial assembly from step 145 to ensure that all user-requested modifications maintain compliance with accuracy requirements, brand standards, and output specifications. This iterative human-AI collaborative workflow produces a finalized video output that reflects the user's creative intent while preserving the integrity and compliance guarantees established throughout the preceding agentic pipeline.

According to various embodiments, content of all modalities (image, text, video, audio, generated research) from both within the software application and external providers (3rd party newswires, stock footage agencies, crowdsourcing platforms, etc.) can be used as source material for content analysis and synthesis. In some embodiments, the multimodal asset management system classifies, chunks, and orchestrates semantic analysis cross video/audio/text/imagery inputs storing semantic metadata in relational databases while also storing semantic encodings in common vector spaces for semantic search and retrieval.

In some embodiments, content segmentation is performed and each piece of content is broken into discrete scenes that embody concepts, quotes, or complete story elements. Additionally key high-interest high-relevant sections of input assets are identified and tagged separately for potential concentrated “highlight” sourcing. In some embodiments, multiple LLM models are used with varying prompts based on earlier classifications of input content (e.g., audio vs text file vs video, etc.) text-to-speech, machine-vision semantic analysis, text summarization are all employed to extract standardized semantic metadata for all scenes, moments, and context for ingested assets.

In some embodiments, the metadata is produced in multiple forms (text, relational records, document-store, as well as multimodal embedding representations of metadata produced in step 142. This metadata cloud enables human search, machine search & retrieval, RAG, as well as enabling semantic associations and moment/scene grouping. In some embodiments, the content metadata database 150 may store metadata for all assets, and sub-assets (scenes & moments) are stored across multiple database types including but not limited to (relational, document-store, vector/embedding) to facilitate content retrieval, RAG, semantic search for recall during content synthesis.

FIG. 1D illustrates a process 100D of prompting a computer model to generate a news story according to an embodiment of the instant solution. Referring to FIG. 1D, a user may input an output format (such as a particular broadcaster) and a template (such as news, entertainment, sports, business, etc.) via the GUI 112 and send the output format and the desired template to the software application 122. In response, the software application 122 may determine a topic of the news story, for example, based on preferences of the user, what is happening that day, or the like, and send a request to the content metadata database 150 for metadata of the topic.

According to various embodiments, the software application 122 may generate a series of prompts (e.g., chain of though prompting) which are fed to the one or more AI models 128. In response, the one or more AI models 128 may generate a script 162 and an edit 164. The script 162 and the edit 164 may be modifiable by the user via the GUI 112.

In some embodiments, a user interacts with the software application via a GUI that enables the user to identify the source materials/topic for their output along with the parameters that determine the stylistic. For example, source material can be sourced from a number of outlets & modalities such as internal content libraries, external newswire sources, AI-automated research generated materials across different modalities (image, audio, video, text, file (pdf), etc.). These sources are semantically analyzed and index by the solution in FIG. 1B and are available for search or generation (in the case of research) as source materials for content generation.

In some embodiments, the software application manages the inputs from the user in sourcing material/research along with selecting or configuring parameters that govern the look and feel of the output. These parameters may include (but are not limited to) target output length, aspect ratio, language, tone, visual style, presenter likeness/voice/personality. The software application leverages multi-agent systems and workflows to perform domain-specific tasks (e.g., script writing, visual editing, etc.) but also includes additional agents a user interacts with directly within the GUI to make targeted feedback-specific changes to the project artifacts.

In some embodiments, the software application may use multi-disciplinary multi-agent systems and workflows to generate content across different domains such as script-writing, language translation, visual editing, transcription, graphics generation (charts, motion-graphics, lower-thirds, etc.), sound effects & scoring. Each domain has its own custom process flow that includes groups of LLM agents across different models performing specialized tasks within their domains. General purpose user-facing agents also retain enough context over project inputs/outputs in order to assist the user with user-feedback-specific requests (eg: “shorten the second block of the script”).

In some examples, the script represents a dialogue-based blueprint representation of the project output that the software application creates based on all source materials selected and made available by the user. This includes presenter voiceover script blocks as well as any direct soundbite blocks (SOTS) selected from the source material that forms a cohesive story narrative. These components are structured in logical blocks that allow concepts/sections of a larger narrative to be unitized supporting additional renditions (languages, edits, formats) to be cut/output from reusing these block-based organizational narrative structures.

In some embodiments, the edit represents an extension of the script and includes visual and additional effects layered on within and on top of the block structures. Presenter visuals, b-roll, primary footage, motion graphics/charts/logos/bugs, sound effects/music, transitions, and other narrative elements are layered on top of the script blueprint until a complete polished narrative is scoped out and represented in the edit. Users are able to interact with and modify all aspects of the script and edit via the script-writing and video-editing tools within the GUI.

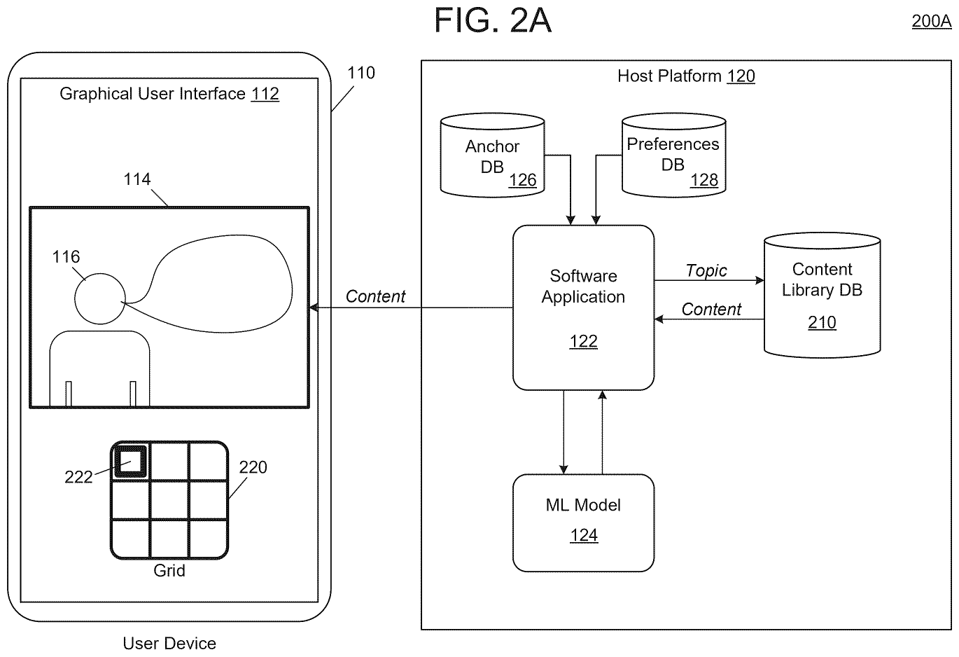

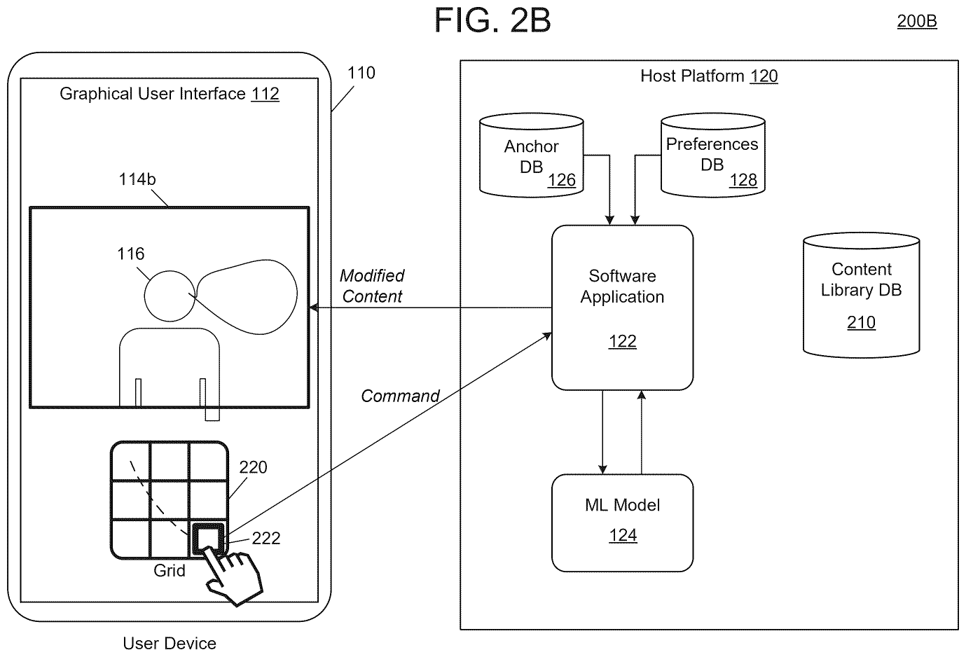

FIG. 2A illustrates a process 200A of playing content with a first level of detail according to an embodiment of the instant solution. Referring to FIG. 2A, the software application 122 may be capable of playing the same news story with different levels of detail (e.g., different amounts of content). There may be multiple versions of the same news story (with multiple differing levels of detail) stored in a library 210. In this way, the software application 122 may output the same news story with different lengths of content, different amounts of content, different types of content, different words and terms, different speeds of speech, different tones, and the like.

According to various embodiments, the software application 122 may display a grid 220 on the GUI 112 of the user device 110. For example, the grid 220 may include a plurality of cells corresponding to a plurality of levels of detail. The grid 220 may also include a movable indicator 222 which can be used to select the level of detail of the news story being played on the GUI 112.

In this example, the movable indicator 222 is initially positioned within a top-left cell of the grid 220. The top-left cell of the grid 220 may correspond to the greatest level of detail, including greatest length, strongest vocabulary, fastest speed and delivery, and the like. Therefore, the software application 122 may retrieve the version of the news story with the most detail from the library 210, and output/play the news story with the most detail on the GUI 112.

FIG. 2B illustrates a process 200B of modifying the content being played to have a second level of detail according to an embodiment of the instant solution. Referring to FIG. 2B, the user may use their finger or other mechanism to move the movable indicator 222 within the grid 220. For example, the user may move the movable indicator 222 from the top-left cell in the grid 220 (corresponding to the greatest level of detail) to the bottom-right cell in the grid 220, as shown in the example of FIG. 2B.

In this example, the bottom-right cell of the grid 220 corresponds to the least level of detail that the news story can be provided with. Here, the selection by the user on the grid 220 can be sent to the software application 122 on the host platform 120. In response, the software application 122 can identify the least-detailed version of the news story within the library 220 and dynamically replace the current news story being played on the GUI 112 with the least-detailed version of the news story. Thus, the user can dynamically change how much detail the news story is provided with during its output.

In the example embodiments, the system can take many types of content as source material. The more content that is ingested, the better the news story that is generated. The data may include raw text, giant PDF file reports, existing video, audio, or anything else. The source material may be combined using the multi-modal computer model. In some embodiments, the data may be recorded on a blockchain ledger that is coupled to the system described herein. The data may be labeled on chain thereby ensuring that the data used to generate the news story can be verified by an auditor.

In the example of FIG. 2A, the system can learn the preferences of a particular user with respect to a level of detail of the news that they like to view. The system can also generate different versions of a news story with different levels of detail. By learning the user preferences, the system can automatically recommend a particular level of detail for the news story and play that version of the news story to begin with. The user may subsequently change the level of detail by clicking on the grid. To achieve this, the system may build a dataset for the user, which is essentially a second brain for the user. The system may store the facts of every story that the user has consumed and how they engaged with the story (e.g., did they watch it until the end or cut it short, did they click on anything, etc.) The system can then use that as a filter essentially as to what the user knows about already and what their preferences are.

In some embodiments, the system may generate up to nine versions of every story (nine levels of detail). It may be dependent on how much data is available when building the story. So all users can use the on-screen grid pop-up to select from available versions. Furthermore, for premium customers, the system may create a custom version of the story.

When the news story is being viewed by the user, the system may also display buttons and other selectable elements corresponding to different topics in the story. For example, for a news story about the city of Los Angeles, a button may be displayed under the viewer which contains the label “Los Angeles”. When the user clicks on the button, the system may provide additional content about the selected topic. Here, the scripts may be broken up into ‘blocks’ which are time-flexible and contain essentially a few sentences. They are time-flexible because it depends on the language it's being spoken in. Regardless, it contains a few sentences which we can tell what the subject matter is. When that particular block is playing (usually about 15-25 seconds) the context of that block would show when the topics button is hit. The model essentially does a lookup into the data source. The system may scrape content from the data source and then summarize it. This processing may happen before the story is played, thereby enabling it to be rendered in real-time while the content is playing. To achieve this, the system may build a knowledge graph based on data contained in the story which is quite reusable for public figures, places, events, and the like.

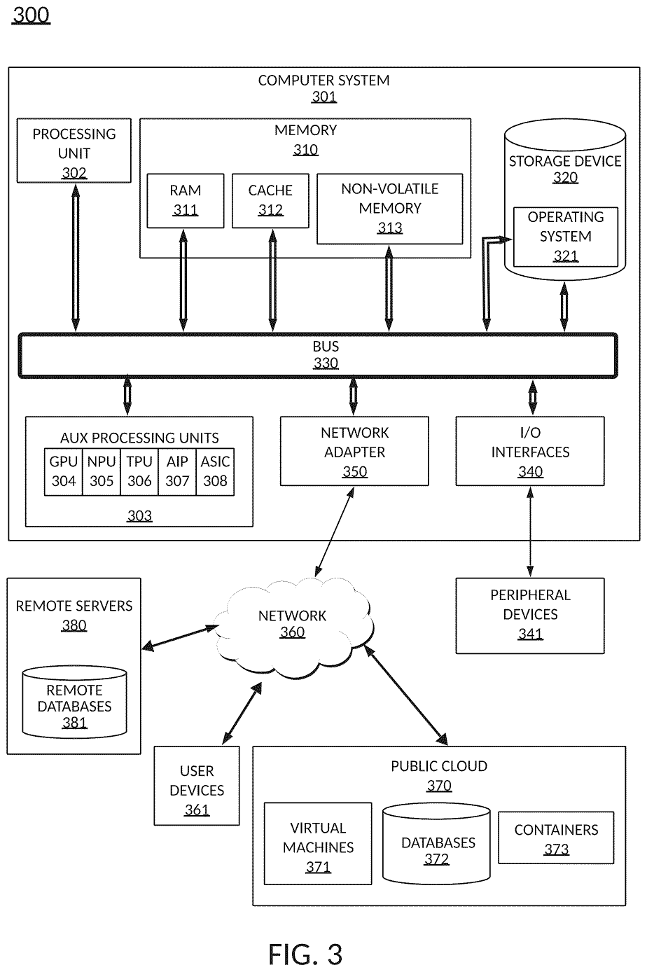

The examples and features of the instant solution may be implemented in at least one of the elements described or depicted herein, including for example, the elements described or depicted in FIG. 3. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 3 illustrates an example computer system architecture, which may represent or be integrated in any of the above-described components, etc.

FIG. 3 illustrates a computing environment according to the instant solution's example features, structures, or characteristics. FIG. 3 is not intended to suggest any limitation as to the scope of use or functionality of features, structures, or characteristics of the instant solution of the application described herein. Regardless, the computing environment 300 can be implemented to perform any of the functionalities described herein. In computing environment 300, there is a computer system 301, operational within numerous other general-purpose or special-purpose computing system environments or configurations.

Computer system 301 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 360 or querying a database. Depending upon the technology, the performance of a computer-implemented method may be distributed among multiple computers and among multiple locations. However, in this presentation of the computing environment 300, a detailed discussion is focused on a single computer, specifically computer system 301, to keep the presentation as simple as possible.

Computer system 301 may be located in a cloud, even though it is not shown in a cloud in FIG. 3. On the other hand, computer system 301 may not be in a cloud except to any extent as may be affirmatively indicated. Computer system 301 may be described in the general context of computer system-executable instructions, such as program modules, executed by a computer system 301. Generally, program modules may include routines, programs, objects, components, logic, data structures, and so on that perform tasks or implement certain abstract data types. As shown in FIG. 3, computer system 301 in computing environment 300 is shown in the form of a general-purpose computing device. The components of computer system 301 may include but are not limited to, at least one processor or processing unit 302, a system memory 310, and a bus 330 that couples various system components, including system memory 310 to processing unit 302.

Processing unit 302 includes at least one computer processor of any type now known or to be developed. The processing unit 302 may contain circuitry distributed over multiple integrated circuit chips. The processing unit 302 may also implement multiple processor threads and multiple processor cores. Cache 312 is a memory that may be in the processor chip package(s) or located “off-chip,” as depicted in FIG. 3. Cache 312 is typically used for data or code accessed by the threads or cores running on the processing unit 302. In some computing environments, processing unit 302 may be designed to work with qubits and perform quantum computing.

The Auxiliary Processing Units (APU) 303 may contain at least one Graphics Processing Unit (GPU) 304, Neural Processing Unit (NPU) 305, Tensor Processing Unit (TPU) 306, AI Processor (AIP) 307, or other Application Specific Integrated Circuit (ASIC) 308. The at least one APU 303 may contain circuitry distributed over multiple integrated circuit chips. Each APU 303 may implement multiple processor threads and multiple processor cores. Each APU 303 may include at least one of onboard memory, onboard memory cache, and onboard instruction cache. Each APU may be communicatively coupled to the system bus 330 and configure to communicate with other system components, including a processing unit 302, system cache 312, RAM 311, non-volatile RAM 313, operating system 321, Network adapter 350, and Input/Output interfaces 340. In some computing environments, at least one of the at least one APU 303 may be designed to work with qubits and perform quantum computing.

Memory 310 is any volatile memory now known or to be developed in the future. Examples include dynamic random-access memory (RAM) 311 or static type RAM 311. Typically, the volatile memory is characterized by random access, but this may not be the characterization unless affirmatively indicated. In computer system 301, memory 310 is in a single package. It is internal to computer system 301, but alternatively or additionally, the volatile memory may be distributed over multiple packages and/or located externally with respect to computer system 301. By way of example, memory 310 can be provided for reading from and writing to a non-removable, non-volatile magnetic media (shown as storage device 320, and typically called a “hard drive”). Memory 310 may include at least one program product having a set (e.g., at least one) of program modules configured to carry out the functions of various features, structures, or characteristics of the instant solution of the application. A typical computer system 301 may include cache 312, a specialized volatile memory generally faster than RAM 311 and generally located closer to the processing unit 302. Cache 312 stores frequently accessed data and instructions accessed by the processing unit 302 to speed up processing time. The computer system 301 may also include non-volatile memory 313 in the form of ROM, PROM, EEPROM, and flash memory. Non-volatile memory 313 often contains programming instructions for starting the computer, including the basic input/output system (BIOS) and information to start the operating system 321.

Computer system 301 may include a removable/non-removable, volatile/non-volatile computer storage device 320. For example, storage device 320 can be a non-removable, non-volatile magnetic media (not shown and typically called a “hard drive”). At least one data interface can connect it to the bus 330. In features, structures, or characteristics of the instant solution where computer system 301 has a large amount of storage (for example, where computer system 301 locally stores and manages a large database), then this storage may be provided by peripheral storage devices 320 designed for storing very large amounts of data, such as a storage area network (SAN) that is shared by multiple, geographically distributed computers.

The operating system 321 is software that manages computer system 301 hardware resources and provides common services for computer programs. Operating system 321 may take several forms, such as various known proprietary operating systems or open-source Portable Operating System Interface type operating systems that employ a kernel.

The bus 330 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 330 is the signal conduction path that allows the various components of computer system 301 to communicate.

Computer system 301 may communicate with at least one peripheral device, 341, via an input/output (I/O) interface, 340. Such devices may include a keyboard, a pointing device, a display, etc.; at least one device that enables a user to interact with computer system 301; and/or any devices (e.g., network card, modem, etc.) that enable computer system 301 to communicate with at least one other computing devices. Such communication can occur via I/O interface 340. As depicted, I/O interface 340 communicates with the other components of computer system 301 via bus 330.

Network adapter 350 enables the computer system 301 to connect and communicate with at least one network 360, such as a local area network (LAN), a wide area network (WAN), and/or a public network (e.g., the Internet). It bridges the computer's internal bus 330 and the external network, exchanging data efficiently and reliably. The network adapter 350 may include hardware, such as modems or Wi-Fi signal transceivers, and software for packetizing and/or de-packetizing data for communication network transmission. Network adapter 350 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 360 is any computer network that can receive and/or transmit data. Network 360 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 360 may be replaced and/or supplemented by LANs designed to communicate data between devices in a local area, such as a Wi-Fi network. The network 360 typically includes computer hardware such as copper transmission cables, optical transmission fibers, wireless transmission, routers, firewalls, switches, gateway computers, edge servers, and network infrastructure known now or to be developed in the future. Computer system 301 connects to network 360 via network adapter 350 and bus 330.

User devices 361 are any computer systems used and controlled by an end user in connection with computer system 301. For example, in a hypothetical case where computer system 301 is designed to provide a recommendation to an end user, this recommendation may typically be communicated from network adapter 350 of computer system 301 through network 360 to a user device 361, allowing user device 361 to display, or otherwise present, the recommendation to an end user. User devices can be a wide array, including personal computers, laptops, tablets, hand-held, mobile phones, etc.

A public cloud 370 is an on-demand availability of computer system resources, including data storage and computing power, without direct active management by the user. Public clouds 370 are often distributed, with data centers in multiple locations for availability and performance. Computing resources on public clouds 370 are shared across multiple tenants through virtual computing environments comprising virtual machines 371, databases 372, containers 373, and other resources. A container 373 is an isolated, lightweight software for running a software application on the host operating system 321. Containers 373 are built on top of the host operating system's kernel and contain software applications and some lightweight operating system APIs and services. In contrast, virtual machine 371 is a software layer with an operating system 321 and kernel. Virtual machines 371 are built on top of a hypervisor emulation layer designed to abstract a host computer's hardware from the operating software environment. Public clouds 370 generally offers databases 372, abstracting high-level database management activities. At least one element described or depicted in FIG. 3 can perform at least one of the actions, functionalities, or features described or depicted herein.

Remote servers 380 are any computers that serve at least some data and/or functionality over a network 360, for example, WAN, a virtual private network (VPN), a private cloud, or via the Internet to computer system 301. These networks 360 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 380 can also host remote databases 381, with the database located on one remote server 380 or distributed across multiple remote servers 380. Remote databases 381 are accessible from database client applications installed locally on the remote server 380, other remote servers 380, user devices 361, or computer system 301 across a network 360. An AI/ML model described or depicted here may reside fully or partially on any of the elements described or depicted in FIG. 3.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

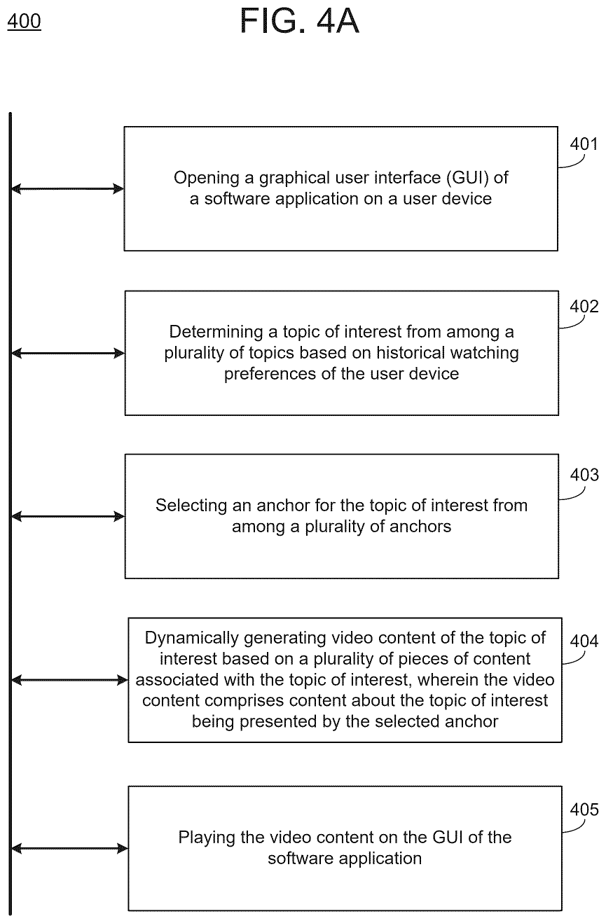

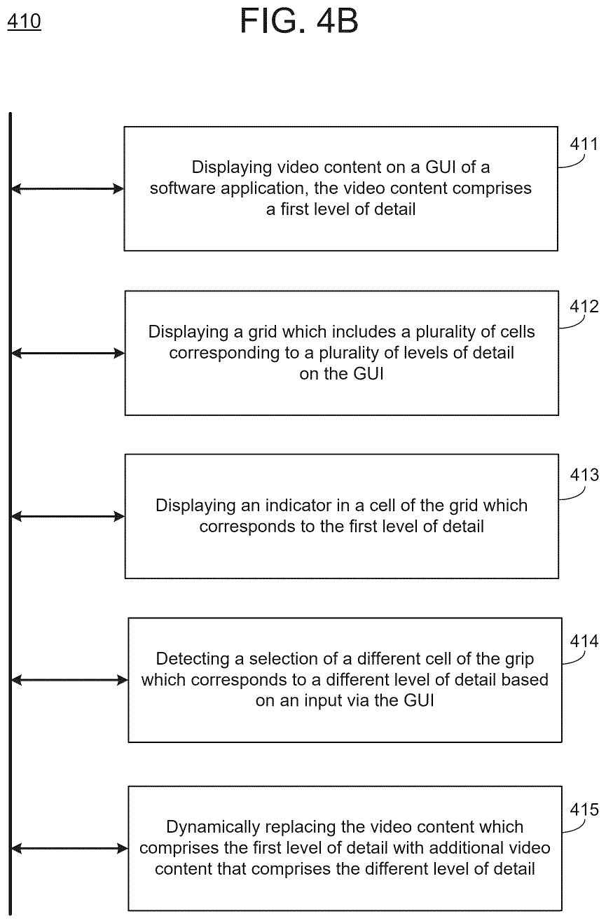

FIG. 4A illustrates a flow diagram of a method 400, according to example embodiments. Referring to FIG. 4A, in 401, the method may include opening a graphical user interface (GUI) of a software application on a user device. In 402, the method may include determining a topic of interest from among a plurality of topics based on historical watching preferences of the user device. In 403, the method may include selecting an anchor for the topic of interest from among a plurality of anchors. In 404, the method may include dynamically generating video content of the topic of interest based on a plurality of pieces of content associated with the topic of interest, wherein the video content comprises content about the topic of interest being presented by the selected anchor. In 405, the method may include playing the video content on the GUI of the software application.

FIG. 4B illustrates a flow diagram of a method 410, according to example embodiments. Referring to FIG. 4B, in 411, the method may include displaying video content on a graphical user interface (GUI) of a software application, the video content comprises a first level of detail. In 412, the method may include displaying a grid which includes a plurality of cells corresponding to a plurality of levels of detail on the GUI. In 413, the method may include displaying an indicator in a cell of the grid which corresponds to the first level of detail. In 414, the method may include detecting a selection of a different cell of the grip which corresponds to a different level of detail based on an input via the GUI. In 415, the method may include dynamically replacing the video content which comprises the first level of detail with additional video content that comprises the different level of detail.

Detailed descriptions of training a machine learning model and executing a machine learning model are further described and depicted herein.

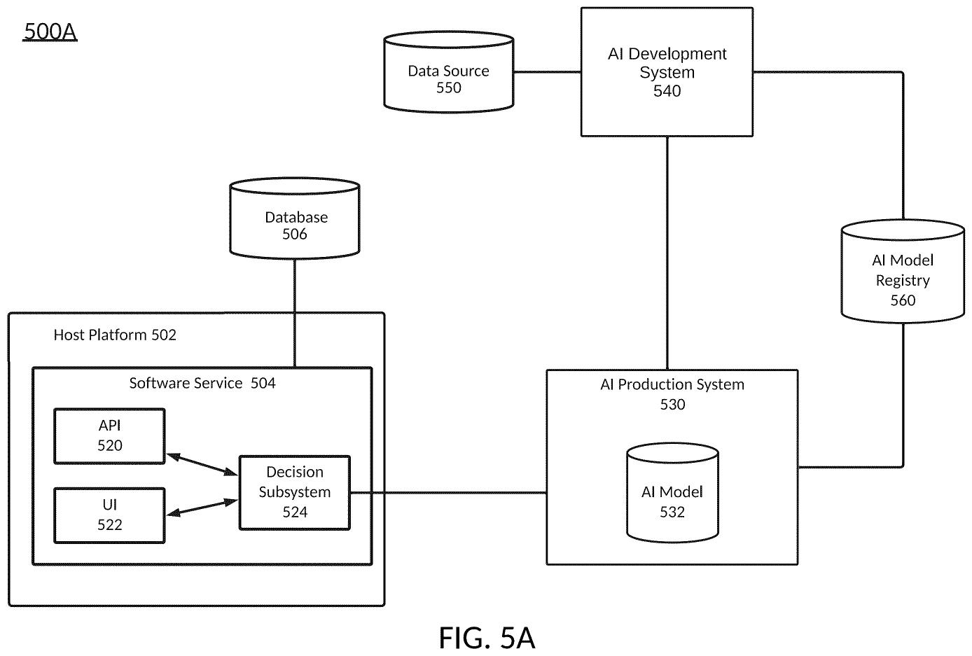

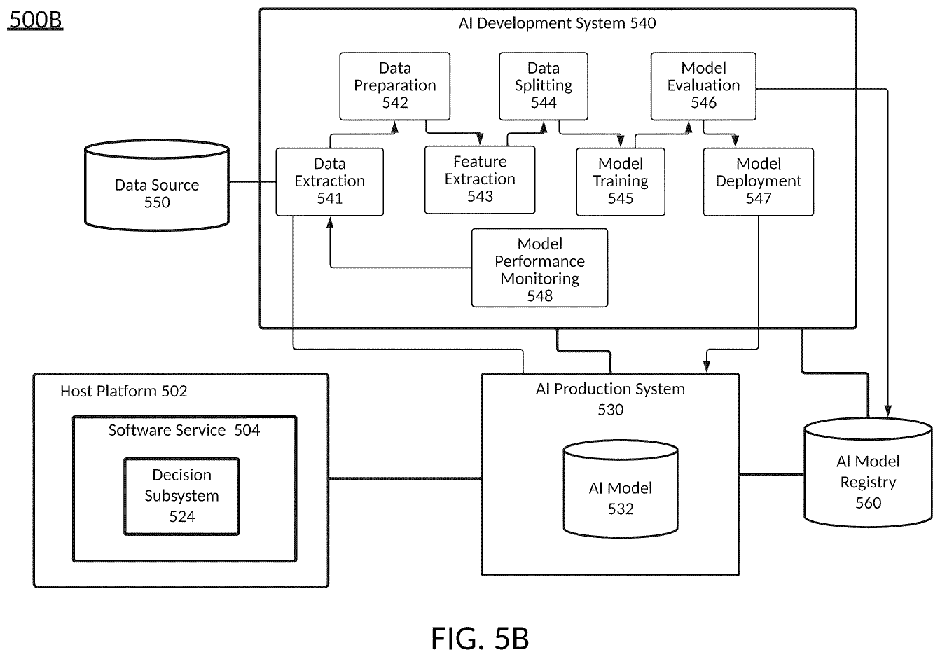

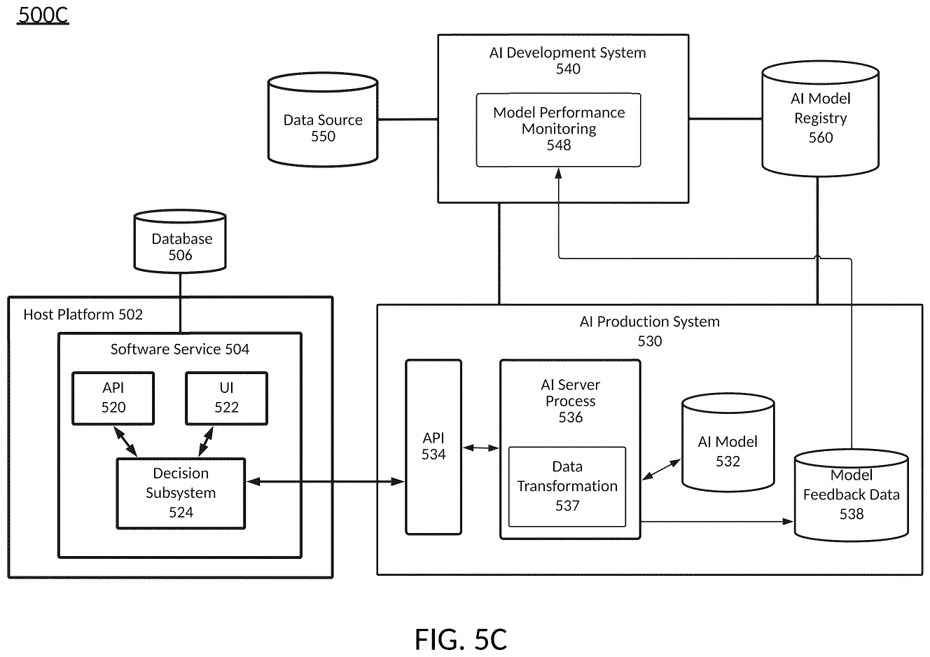

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content - such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx. ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

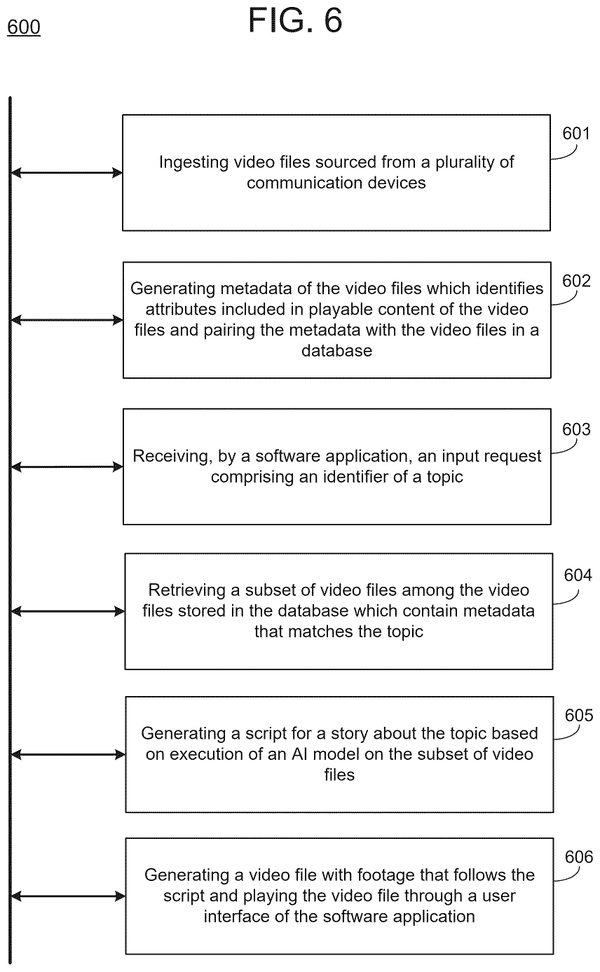

FIG. 6 illustrates an example of a method 600 dynamically generating content according to examples and features of the instant solution. As an example, the method 600 may be performed by a computing system, a software application, a server, a cloud platform, a combination of systems, and the like. Referring to FIG. 6, in 601, the method may include ingesting video files sourced from a plurality of communication devices. In 602, the method may include generating metadata of the video files which identifies attributes included in playable content of the video files and pairing the metadata with the video files in a database. In 603, the method may include receiving, by a software application, an input request comprising an identifier of a topic. In 604, the method may include retrieving a subset of video files among the video files stored in the database which contain metadata that matches the topic. In 605, the method may include generating a script for a story about the topic based on execution of an artificial intelligence (AI) model on the subset of video files. In 606, the method may include generating a video file with footage that follows the script and playing the video file through a user interface of the software application.

In some embodiments, the method may include detecting objects represented in frames of video within the video files and storing object identifiers of the objects within the metadata. In some embodiments, the method may include determining a location depicted in the video files based on at least one of visual landmarks, geotags, and environmental indicators and storing the location within the metadata. In some embodiments, the method may include generating narrative units that reference at least one of objects, persons, locations, actions, and events identified in corresponding metadata of the subset of video files. In some embodiments, the method may include generating an alternate version of the script using the AI model, in response to a request to adjust at least one attribute of the script from the user interface, and storing the alternate version with the script for comparison.

In some embodiments, the method may include receiving, from the user interface, a request to modify a portion of the script and updating only the portion of the script using the AI model based on the request while maintaining a remaining portion of the script unchanged. In some embodiments, the method may include generating a first-cut edit for the script by selecting, for a script segment, a video clip from the subset of video files that contains metadata that most closely corresponds to descriptors of the script segment within the script. In some embodiments, the method may include aligning presenter narration included in the subset of video files based on timing instructions included in the script to generate the video file. In some embodiments, the method may include receiving a natural language instruction describing an edit to a timeline of the video, determining a change to perform from the edit using the AI model, and modifying a selected portion of the timeline to perform the change.

In some embodiments, the method may include playing the additional video content on the GUI and overlaying the grid on the additional video content with a visual indicator within the different cell identifying a currently selected level of detail. In some embodiments, the grid may include at least one of a 2×2 matrix, a 3×3 matrix, a 4×4 matrix, and a 5×5 matrix of selectable cells. In some embodiments, the method may include determining a recommended level of detail for initially displaying the video content based on historical viewing behavior, wherein the displaying the video content comprises automatically displaying the video content with the recommended level of detail. In some embodiments, the method may include modifying the video content at the first level of detail with an artificial intelligence (AI) model to generate the additional video content at the different level of detail based on the selection of the different cell.

In some embodiments, the system may also include a user interface for generating and editing a video according to examples and features of the instant solution.

In one example, the system may collect materials for generating a story and display the materials through a user interface. The system may collect video, audio, web links, text, and similar items, and it can reference web links by URL or accept uploaded files or items identified by an associated identifier. The materials may be added to a bin that functions as a container of selected content. A user may add an item as a primary source or a secondary source. Primary sources are fully ingested so that all elements of the material are considered, while secondary sources are partially ingested so that only selected aspects such as footage, audio, or visuals are used. During the story generation process, the user may continue adding material to the bin and may label each item as primary or secondary depending on how it should influence the resulting story.

In some embodiments, a first AI agent may analyze each piece of input material and extract metadata from it. When the input is text, the system reads the text. When the input is audio, the system can transcribe the audio into text. When the input is video, the system can divide the video into a sequence of clips and apply a scene detection algorithm to identify clips associated with speech, interviews, thoughts, general footage, and the like, without speech. For clips containing speech, the system can generate a timestamp for each spoken word.

The system may preserve attributes such as clip length, language, region, type, and copyright usage. The system further analyzes each video clip to summarize the scene and generate descriptive information including shot type, location, time of day, identities and activities of people, and the subject matter of the discussion. The system may also generate comments on the clip, assign a rating that reflects the quality of the content, and compute a minimum recommended duration for using the clip. This metadata is produced for use by subsequent artificial intelligence agents in later stages of the workflow.

The system may also detect objects in the background of a scene and generate descriptive metadata for those objects. For example, if a speaker appears in front of multiple flags, the system may recognize the flags and identify the entities they represent. The system may further assign a quality rating to each clip based on factors such as whether the video was professionally captured or taken from a consumer device.

A user may then specify a title, select an anchor, choose voices with particular tones or emotions, select a country and a language, and optionally enable a personality injection feature that applies a fine-tuned personality to an artificial intelligence generated anchor. The user can select among multiple available voices for the anchor, including voices that differ in tone, speed, and emotional expression. The artificial intelligence generated anchor can then deliver the story content in a manner that reflects the selected personality and voice characteristics.

In some embodiments, a second AI agent may generate a script for the anchor to speak, and the system presents a script editor through the user interface. The user may edit portions of the text or audio content that will be included in the story by using a slider mechanism associated with each piece of source material. Each source item can be modified in this manner so that the user can fine tune how the item is used. The system may collect soundbites extracted from the metadata and allow the user to select which portions will be included or excluded. The script editor also identifies source materials not currently used, allowing the user to add or remove items. In some embodiments, the second AI agent may generate the script automatically, and the user may modify it as needed. For example, if the user dislikes a paragraph, the user may request regeneration of that portion, resulting in a newly generated alternative. The initial version of the script may be treated as a first cut that the user may further adjust.

According to various embodiments, the system may provide different video editing modes. A user familiar with timeline editing may adjust the placement and duration of video clips along a timeline. Alternatively, the script may be divided into script blocks that can be edited individually. The user can assign different pieces of footage to each block and can adjust the length of footage by moving the edges of the associated clip. This allows the user to extend or reduce the duration of a video segment within the story.

The system may also support spoken editing commands referred to as executive notes, allowing a user to verbally request changes that the system interprets and applies. The user may request new script versions, modify existing blocks, adjust content placement, or request other edits through voice input. The system may convert the spoken input to text, determine the requested edits, and apply the appropriate changes. The script editor may provide tools to quickly adjust blocks of script and associated footage, and the system displays the materials used to generate each block so the user can modify them. The system may allow detailed analysis of each script segment and provides separate interfaces for script editing and video editing, while artificial intelligence agents operate in the background to support these functions. When the script reaches a completed state, the system presents it to the user to indicate that it is ready for the next stage of production.

In some embodiments, the system described herein may use AI to perform advertisement personalization. In this case, the system understands the user's content preferences and intentions, and then serves appropriate advertisement when contextually appropriate. This may be a different ad, or a different version of the same ad targeted as specific demographics. This could also include an ad generated specifically for that specific user. The system understands the user's desire to learn about a specific topic. Here, the system could dynamically place and price ads depending on these preferences. For example, an advertiser may spend more money to reach a user that is more enthusiastic about a specific topic over a user that is less interested.

Furthermore, the system also provides an adaptive cut. For example, the system is capable of taking the initial cut of a video (film, tv episode, other) as well as the raw assets used to make that video, and then adapting the edit and material to a specific demographic or specific user. Each scene of a video could be lengthened, shortened, dialogue could be adjusted or cut down, music could be altered, and other methods to change the characteristics of that scene. Final videos could vary significantly and would be more appealing to end users based on their preferences.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

1. A method comprising:
ingesting video files sourced from a plurality of communication devices;
generating metadata of the video files which identifies attributes included in playable content of the video files and pairing the metadata with the video files in a database;
receiving, by a software application, an input request comprising an identifier of a topic;
retrieving a subset of video files among the video files stored in the database which contain metadata that matches the topic;
generating a script for a story about the topic based on execution of an artificial intelligence (AI) model on the subset of video files; and
generating a video file with footage that follows the script and playing the video file through a user interface of the software application.

2. The method of claim 1, wherein the generating the metadata comprises detecting objects represented in frames of video within the video files and storing object identifiers of the objects within the metadata.

3. The method of claim 1, wherein generating the metadata comprises determining a location depicted in the video files based on at least one of visual landmarks, geotags, and environmental indicators and storing the location within the metadata.

4. The method of claim 1, wherein the generating the script comprises generating narrative units that reference at least one of objects, persons, locations, actions, and events identified in corresponding metadata of the subset of video files.

5. The method of claim 1, further comprising generating an alternate version of the script using the AI model, in response to a request to adjust at least one attribute of the script from the user interface, and storing the alternate version with the script for comparison.

6. The method of claim 1, further comprising receiving, from the user interface, a request to modify a portion of the script and updating only the portion of the script using the AI model based on the request while maintaining a remaining portion of the script unchanged.

7. The method of claim 1, further comprising generating a first-cut edit for the script by selecting, for a script segment, a video clip from the subset of video files that contains metadata that most closely corresponds to descriptors of the script segment within the script.

8. The method of claim 1, wherein the generating the video file comprises aligning presenter narration included in the subset of video files based on timing instructions included in the script to generate the video file.

9. The method of claim 1, further comprising receiving a natural language instruction describing an edit to a timeline of the video, determining a change to perform from the edit using the AI model, and modifying a selected portion of the timeline to perform the change.

10. An apparatus, comprising:
a memory; and
a processor communicatively coupled to the memory, the processor configured to:
ingest video files sourced from a plurality of communication devices;
generate metadata of the video files which identifies attributes included in playable content of the video files and pairing the metadata with the video files in a database;
receive, by a software application, an input request comprising an identifier of a topic;
retrieve a subset of video files among the video files stored in the database which contain metadata that matches the topic;
generate a script for a story about the topic based on execution of an artificial intelligence (AI) model on the subset of video files; and
generate a video file with footage that follows the script and playing the video file through a user interface of the software application.

11. The apparatus of claim 10, wherein the processor is configured to detect objects represented in frames of video within the video files and store object identifiers of the objects within the metadata.

12. The apparatus of claim 10, wherein the processor is configured to determine a location depicted in the video files based on at least one of visual landmarks, geotags, and environmental indicators and storing the location within the metadata.

13. The apparatus of claim 10, wherein the processor is configured to generate narrative units that reference at least one of objects, persons, locations, actions, and events identified in corresponding metadata of the subset of video files.

14. The apparatus of claim 10, wherein the processor is further configured to generate an alternate version of the script using the AI model, in response to a request to adjust at least one attribute of the script from the user interface, and store the alternate version with the script for comparison.

15. The apparatus of claim 10, wherein the processor is further configured to receive, from the user interface, a request to modify a portion of the script and update only the portion of the script using the AI model based on the request while maintaining a remaining portion of the script unchanged.

16. The apparatus of claim 10, wherein the processor is further configured to generate a first-cut edit for the script by selecting, for a script segment, a video clip from the subset of video files that contains metadata that most closely corresponds to descriptors of the script segment within the script.

17. The apparatus of claim 10, wherein the processor is configured to align presenter narration included in the subset of video files based on timing instructions included in the script to generate the video file.

18. The apparatus of claim 10, wherein the processor is further configured to receive a natural language instruction describing an edit to a timeline of the video, determine a change to perform from the edit using the AI model, and modify a selected portion of the timeline to perform the change.

19. A computer program product, comprising:
at least one computer-readable storage media; and
program instructions stored on the at least one computer-readable storage media to perform operations comprising:
ingesting video files sourced from a plurality of communication devices;
generating metadata of the video files which identifies attributes included in playable content of the video files and pairing the metadata with the video files in a database;
receiving, by a software application, an input request comprising an identifier of a topic;
retrieving a subset of video files among the video files stored in the database which contain metadata that matches the topic;
generating a script for a story about the topic based on execution of an artificial intelligence (AI) model on the subset of video files; and
generating a video file with footage that follows the script and playing the video file through a user interface of the software application.

20. The computer program product of claim 17, wherein the generating the metadata comprises detecting objects represented in frames of video within the video files and storing object identifiers of the objects within the metadata.
